(19) United States
(12) Patent Application Publication
(10) Pub. No.: US 2005/0129219 A1
(43) Pub. Date: Jun. 16, 2005

(54) Method and apparatus for dialing from a directory for a communication terminal

(76) Inventor: Robert Williamson, Aurora (CA)

Correspondence Address: Mr. William B. Vass;c/o Ridout & Maybee LLP, Suite 2400, One Queen Street East, Toronto, ON, M5C 3B1, CA

(21) Appl. No.: 10/733,344

(22) Filed: Dec. 12, 2003

(51) Int. Cl. H04M 1/00; H04M 3/00

(52) U.S. Cl. 379/355.04; 379/352

(57) ABSTRACT

A method and apparatus for dialing a number from a directory for a communication terminal. The system is responsive to one or more digits entered by the user using a key pad for the communication terminal. The entered digits are stored as a string and compared to the entries stored in the directory. The entries in the directory comprise a directory number and may include a name associated with the directory number. The entered digits are compared to both the directory numbers and the names for each of the directory entries. Matches on either the directory numbers and/or the names are retrieved and displayed for the user. Using a navigation key, the user is able to select one of the retrieved directory entries and dial the number by going off-hook. If more than one directory entry is matched, additional digits may be entered by the user to narrow the list of retrieved entries. Once a single directory entry is matched, the number is dialed by going off-hook.

### FIELD OF THE INVENTION

The present invention relates to communication systems and moire particularly to a method and apparatus for pre-dialing from a directory for a telephone, Internet phone or other type of communication terminal.

### BACKGROUND OF THE INVENTION

In the art, there are known directory-based dialing systems for assisting in the dialing of a number from a telephone having a directory.

The known directory-based dialing systems typically require a user to first launch the directory and explicitly search and find the desired entry in order to place a call This entails extra steps. In addition, there is a physical and conceptual separation between normal or conventional dialing using the dial pad and the directory-based dialing. This increases the cognitive load on users because the:y need to remember and apply two sets of procedures or steps for dialing a call.

In the art, there are also directory applications that allow the user to assign a short-cut code, i.e. a “speed dial”, to a given directory entry. The short-cut code or speed dial comprises one or two digits which are accessed via the dial or key pad. While providing a saving in keystrokes for initiating a call, such systems still place a cognitive load a user by requiring the user to remember codes. Furthermore, the codes are arbitrary and have no particular relationship to the telephone number or name of the person that the user wishes to call. While this may be manageable for a user having a few static personal directory entries, it is not workable for corporate directories or for dynamic caller logs. Corporate directories typically include hundreds or even thousands of entries. Dynamic caller logs typically require specific additional user effort to configure and maintain.

Accordingly, there remains a need for a new and improved directory-based dialing system and improvements in the operation of directory-based dialing systems

### BRIEF SUMMARY OF THE INVENTION

The present invention provides a method and apparatus for pre-dialing from a directory for a telephone, Internet phone, Internet phone computer or other type of communication terminal.

In a first embodiment, the present invention provides an apparatus for dialing a number for a communication terminal, the number is stored in a directory with a plurality of numbers, the communication terminal includes a key pad for a user the apparatus comprises: an input for receiving digits entered by the user using the key pad; a comparator for comparing the received digits to a plurality of directory entries stored in the directory; a component for retrieving directory entries matching the received digits; a display for displaying the retrieved directory entries; a component for prompting the user for an additional entry in response to more than one matched directory entry being displayed; a component for selecting one of the retrieved directory entries, a component for dialing the number associated with the selected directory entry.

In another embodiment, the present invention provides a method for dialing a number stored in a directory for a communication terminal, the communication terminal includes a key pad for a user to enter digits, the method comprises the steps of: accepting one or more digits entered by the user; comparing the entered digits to a plurality of entries stored in the directory; retrieving entries having digits matching the digits entered by the user; prompting the user for an additional input if the retrieved entries comprise more than one entry; selecting one:! of the retrieved entries in response to the additional input by the user; dialing the number associated with the selected entry.

In yet another embodiment, the present invention provides a system for pre-dialing a number stored in a directory for a communication terminal, the communication terminal includes a key pad for a user to enter digits, the method comprises: means for inputting one or more digits entered by the user; means for comparing the entered digits to a plurality of entries stored in the directory; means for retrieving entries having digits matching the digits entered by the user; means for prompting the user for an additional input if the retrieved entries include more than one entry; means for selecting one of the retrieved entries in response to the additional input by the user; means for pre-dialing the number associated with the selected entry.

Other aspects and functions of the present invention will become apparent to those ordinarily skilled in the art upon review of the following description of specific embodiments of the invention in conjunction with the accompanying drawings.

### BRIEF DESCRIPTION OF THE DRAWINGS

Reference is next made to the accompanying drawings which show, by way of example, embodiments of the invention and in which:

FIG. 1 shows in diagrammatic form an Internet phone system utilizing a pre-dialing system in accordance with the present invention;

FIG. 2 shows in flow-chart form a process for pre-dialing a number in accordance with the present invention; and

FIG. 3 shows in diagrammatic form a directory configuration for the operation of the pre-dialing mechanism in accordance with the present invention; and

FIG. 4 shows in diagrammatic form operation of the pre-dialing mechanism utilizing the directory configuration of FIG. 3.

In the drawings, like reference numerals indicate like elements

### DETAILED DESCRIPTION OF THE EMBODIMENTS

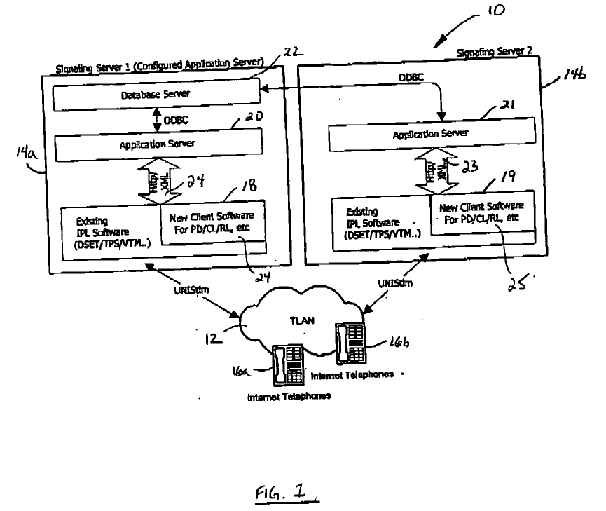

Reference is first made to FIG. 1 which shows in diagrammatic form an Internet phone system utilizing a dialing system according to the present invention. The Internet phone system is indicated generally by reference 10. While the present invention is described in the context of an Internet phone system, it will be appreciated that the invention has wider applicability and is suitable for other telecommunication systems or communication terminals.

As shown in FIG. 1, the Internet phone system 10 comprises a communication network 12 (i.e. the Internet), signaling servers 14, and Internet telephones or communication terminals 16 indicated individually as 16a and 16b . The Internet telephone may comprise the i2000™ series Internet telephones from Nortel Networks Inc. The phone or communication terminal may also comprise a “soft-phone” which is implemented as a software simulation of a physical telephone sel: or an Internet phone. In FIG. 1, two signaling servers 14 are shown, signaling server 1 and signaling server 2. The communication network 12 comprises the Internet which is formed as a network of networks and provides a wide area network for communication according to standardized Internet protocols as will be within the understanding of those skilled in the art.

The signaling server 1, indicated by reference 14a , comprises a configured application server. The configured application server 14a includes an IPL software module 18, an application server 20, and a database server 22. The application server 20 interfaces to-the IPL software module 18 through a HTTP based XML interface 24. The IPL software module 18 allows multiple clients, for example, Internet telephones 16, to access the given application, i.e. the application server 20. The application server 20 runs application logic which allows the application server 20 to control the display, user interaction and other functions, on the Internet telephones 16 through the IPL software module 18, for example, using an IPL line LTPS mechanism. The application server 20 interfaces to the database server 22 through an ODBC interface The database server 22 also interfaces through the ODBC interface to an application server 21 on the signaling server 2. As shown in FIG. 1, the other server 14b (i.e. signaling server 2) includes the application server 21 and an IPL software module 19. The application server 21 interfaces to the IPL software module 19 through a HTTP based XML interface 23. The application server 21 runs application logic to control functions on the Internet telephone 16 through the IPL software module 19.

As also shown in FIG. 1, the IPL software module 18 includes a client software module indicated by reference 24. The client software module 24 runs as a web based application, and provides telephony and other communication features for the Internet telephone 16a , such as Personal Directory, Redial List and Callers List. Similarly, the IPL software module 19 for the signaling server 2 includes a client software module 25 which provides telephony and web based functionality for the Internet phone 16b . The dialing system in accordance with the present invention may be implemented in firmware in the phone and/or software in the IPL software module 18, 19 as part of the client software module 24, 25.

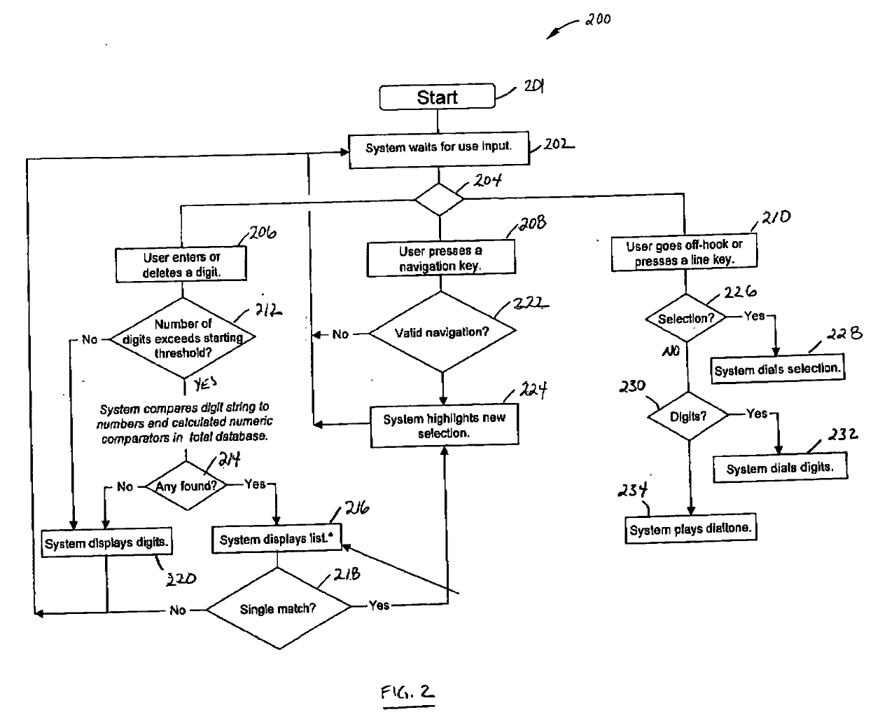

Reference is next made to FIG. 2, which shows in flow-chart form a process for pre-dialing a number from a directory for the Internet telephone 16 (FIG. 1) or other type of telephone or communication terminal. In FIG. 2, the pre-dialing process is indicated by reference 200. The process may be implemented as a procedure or functions in firmware or software executed by a microprocessor or embedded controller (not shown) operating in the communication terminal 16 or operating on a server in conjunction with the communication terminal 16. The suitably programmed microprocessor and/or server software component is referred to as “the system” in following description.

As shown in FIG. 2, the process 200 is initiated (block 201) and the system waits for an input from the user block 202. Inputs from the user include a digit or letter entered using the keypad or dial pad on the terminal, as indicated by block 206; a navigation key pressed by the user, as indicated by block 208; or a line but:on pressed by the user, or the user going off-hook by lifting the handset, as indicated by block 210. The type of input is determined in a decision block 204, for example, as part of keypad scan function implemented in firmware and/or hardware.

Referring still to FIG. 2, if the user enters or deletes a digit/letter using the keypad (block 206), then the entered digit is added to a string stored in memory, or deleted from the string as the case may be. A check is then made at decision block 212 to determine if the number of digits entered meets or exceeds a starting threshold number. The starting threshold number (for example, 2 digits/letters) is defined in software as the minimum of entered digits/letters for initiating a search of the database(s) and retrieve matching entries. If the condition for the starling threshold number is satisfied, then the system compares the string formed from the entered digits/letters to the entries stored in one or more databases in the communication terminal 16 (FIG. 1), the server 14, or accessible from the communication terminal 16. If there are matches as determined in decision black 214, then the system will display the matched entries on the user display of the communication terminal 16. If there is not a single match as determined in decision block 218, then the system waits for further input from the user (block 202). Referring to decision block 212, if the number of digits entered by the user (as determined from the string of digits/letters stored in memory) does not exceed the starting count or threshold, then the system displays the entered digits/letters (i.e. string) on the user display as indicated in block 220. Similarly, if no matches are found in the database(s) searched by the system as determined in decision block 214, then the system displays the entered digits/letters on the user display, as indicated in block 220.

According to another aspect, additional logic may be applied or implemented by the system in displaying the list entries matched from the searched database(s) in block 216. Additional logic implemented in firmware and/or software includes sorting, for example, sorting by alpha, sorting by numeric order, frequency of use, or assigned priority of the source directory (e.g. personal entries before public entries), or some combination based on user specified or programmed preferences. The additional logic may also include display limits, for example, only show matched entries if less than 10, or only show the matched single result.

Referring back to FIG. 2, if a user presses a navigation key (block 208) as determined in decision block 204, then a check is made in decision block 222 to determine if the navigation key pressed by the user is valid for the present state of operation. If the pressed navigation key is not valid, the system waits for another input from the user (block 202) The system may include code to notify the user of an invalid navigation key press (not shown). If the pressed navigation key is valid (decision block 222), then the system highlights a new selection, for example, a soft key or menu or list box selection, as indicated by block 224. The system then waits for another input from the user (block 202).

Referring again to FIG. 2, if the user goes off-hook or presses a line key (block 210) as determined in decision block 204, then a check is made in decision block 226 to determine if there is a match or selection (i.e. either through manual or automatic selection) from the database(s) which were searched. If there is a selection, then the system dials the telephone number or directory number (DN) associated with the selection, as indicated in block 228. If there is no selection (decision block 226), then a check is made for digits entered by the user (and stored in the form of string in memory) in decision block 230. If there are digits, then the system dials the digits as indicated in block 232 If there are no digits, or insufficient digits (if such logic is programmed in firmware and/or software), then the system initiates dial tone or an off-hook state (block 234) and does not dial any digits.

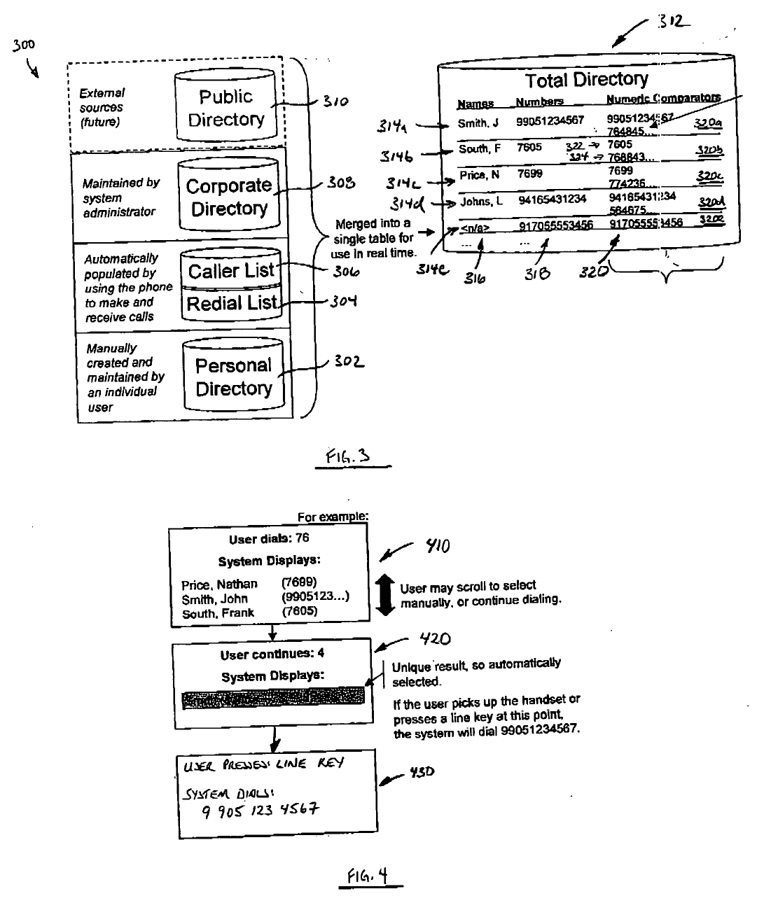

Reference is next made to FIG. 3, which shows in diagrammatic form an exemplary directory arrangement and the pre-dialing operation for an Internet telephone 16 (FIG. 1) in accordance with the present invention. The directory arrangement is indicated generally by reference 300, and comprises a number of individual directories including a personal directory 302, a caller list directory 304 a redial list directory 306, a corporate directory 308 and a public directory 310. The directories 302, 304, 306, 308, 310 may be configured on a common server and synchronized with external sources. For example, the personal directory 302 is managed from a “contacts” file maintained on a personal computer, or corporate data from a human resources database. According to another aspect, the directory data is located on a host, where the host may comprise a dedicated server, a LAN (Local Area Network), a WAN (Wide Area Network) or a local database (i.e. operating on the telephone set or the computer for a “soft-phone” implementation).

To conduct a search in accordance with the pre-dialing procedure, the individual directories 302 to 310 may be merged into a single table, total directory or virtual directory for searching in real time and indicated by reference 312. As shown in FIG. 3. the single directory 312 comprises a record 314 (i.e. row) for each directory entry, indicated individually as 314a , 314b , 314c, 314d . . . Each record 314 includes a number of information fields (i.e. columns). The record 314 includes a name column 316 and a number (i.e. directory number or DN) column 318. The name column 316 lists the alphabetic name associated with the directory number 318 in each of the records 314. As shown for the record 314e, an alphabetic name may not be included in the row, and the directory number 318 serves as the primary identifier or field for each of the records 314. To facilitate searching according to the pre-dialing procedure 200 (FIG. 2) according to the present invention, the single or total directory 312 may include a third column for numeric comparators indicated l)y reference 320, indicated individually for each of the records by 320a , 320b , 320c, 320d, 320e, . . . Each of the numeric comparator columns 320 includes a numeric equivalent field 322 for the directory number, and a numeric equivalent field 324 for the alphabetic name (if available or entered) associated with the directory number. In most cases, the numeric equivalent for the directory number is the same as the directory number. However, there may be cases where the directory number is encoded or otherwise translated from the corresponding dial pad digit keys. The numeric equivalent for the alphabetic name comprises digits mapped from the telephone keypad. For example, the first record 314a comprises the directory number 318a “9 905 123 4567” and the alphabetic name 316a “Smith, J”. The directory number is represented in the numeric comparator column 320 as “99051234567”. The alphabetic name is mapped in the numeric comparator column 320 as “764815”, where 7=PQRS, 6=MNO, 4=GHI, 8TUV, 4=GHI, 5=JKL (where the underscore indicates the mapped letter in the name). Using the numeric comparator column 320, the pre-dialing procedure searches for a directory entry by matching the user entered digits to the directory number or the alphabetic name or both.

In operation for pre-dial mode, i.e. before the handset is lifted or a line button pressed so that there is no dial tone, the user begins by pressing keys on the dial pad, either entering digits for a telephone number or digits to spell a person's name. The resulting string of entered digits is compared against both numeric and alphabetic entries in the directory database simultaneously. For example, pressing the “2” key narrows the list to all entries of people with names beginning with the letters “A”, “B” or “C”, and with telephone numbers beginning with the number “2”. If the “2” key press is followed by pressing the “3” key, then the possible retrieved entries include people with telephone numbers beginning with “23” or with names beginning with “2D, 2E, 2F, A3, AD, AE, AF, B3, BD, BE, C3, CD, CE, or CF”. It will be appreciated that the actual results are limited by the number of likely combinations. According to this aspect, special characters, such as hyphens, apostrophes, spaces, etc., may be skipped.

According to another aspect, results are not displayed on the user display until the number of matching entries are narrowed to a pre-defined useful threshold in order to conserve computational resources. In addition, the higher number of retrieved entries presented to the user does not necessarily save user time and therefore the longer list is not that useful.

Once the list of retrieved entries is limited (i.e. to the pre-defined threshold) and presented on the display unit, the user may continue to enter digits/letters using the keypad to further narrow the entries. The user may also use navigation keys/controls on the terminal to narrow the entries, for example, scrolling through the list of entries and selecting the desired entry. On the other hand, if the digits or letters entered by the user result in a unique entry, then the retrieved entry is automatically displayed and shown as selected on the user display. Once the desired entry has been selected, automatically or by the user, then the user simply needs to lift the handset or select a line button the phone to initiate the call and dial the number. If the user attempts to initiate a call without having made a directory entry selection, then whatever digits have been entered by the user, i.e. using the keypad, are dialed. In such a situation, the entered digits may comprise a complete telephone number which just does not happen to be stored in any of searched directories. According to a further aspect, if at any point the digits/letters entered by the user no longer match any entry stored in the searched databases, then the user displace for the terminal is returned to a standard or default pre-dial display screen showing the entered digits, and as such normal digit-based dialing remains unaffected

Reference is made to FIG. 4, which shows an example for the directory configuration 312 of FIG. 3 In response to the user entering the digits “76” using the dial pad, the pre-dial procedure (as described above with reference to FIG. 2) retrieves the directory entries for “Price, Nathan”, “Smith, John”, and “South, Frank,” The pre-dial procedure matches “76” to the numeric comparator for the directory number “7699” associated with “Price, Nathan”, the numeric comparator for the alphabetic name “764845” for “Smith, John”, and the numeric comparators for the directory number “7605” and for the alphabetic name “768843” for “South, Frank”, and displays the directory entries, i.e. name and directory number, for these three matches as indicated by reference 410 in FIG. 4. The user next enters the digit “4” using the dial pad. This results in the pre-dial procedure matching the directory entry for “Smith, John”, i.e. the entered digits “764” are matched to the numeric comparator “764845” for the alphabetic name “Smith, John”, and the searched result is displayed, as indicated by reference 420 in FIG. 4. Since the searched result is unique, the pre-dial procedure automatically selects the displayed directory entry, e.g. by highlighting the entry. If the user then selects a line or lifts the handset to take a line, then the system automatically the directory number for the selected directory entry, as indicated by reference 430 in FIG. 4.

It will be appreciated that the actual number of keystrokes required to resolve a directory entry depends on the directory size and content of the directory. For a typical North American directory having mixed English and international names in the English alphabet, it has been found that for a corporate directory having approximately 500 entries for employees, almost 80% of the employees can be uniquely identified using four keystrokes or less and knowing nothing more about the employees than their last names. The efficiency rate rises to about 90% using five or less keystrokes. It will also be appreciated that for non-English language directory entries, performance may be impaired based on the diversity of names as influenced by language, character set, and culture.

The present invention may be embodied in other specific forms without departing from the spirit or essential characteristics thereof. Other adaptations and modifications of the invention will be obvious to those skilled in the art. Therefore, the presently discussed embodiments are considered to be illustrative and not restrictive, the scope of the invention being indicated by the appended claims rather than tile foregoing description, and all changes which come within the meaning and range of equivalency of the claims are therefore intended to be embraced therein.

1. An apparatus for dialing a number for a communication terminal, said number being stored in a directory with a plurality of numbers, said communication terminal having a key pad for a user, said apparatus comprising:
an input for receiving digits entered by the user using the key pad;
a comparator for comparing said received digits to a plurality of directory entries stored in the directory;
a component for retrieving directory entries matching said received digits;
a display for displaying said retrieved directory entries;
a component for prompting the user for an additional entry in response to more than one matched directory entry being displayed;
a component for selecting one of the retrieved directory entries;
a component for dialing the number associated with the selected directory entry.

2. The apparatus as claimed in claim 1, further including a counter for counting the digits received, and said comparator being responsive to said counter when a pre-determined number of digits are received.

3. The apparatus as claimed in claim 2, wherein said directory entries comprise the number and a name, said name being mapped to digits on the key pad.

4. The apparatus as claimed in claim 31 wherein said comparator includes a component for comparing said received digits to the number for each of said directory entries and a component for comparing said received digits to the digits mapped to the name for each of said directory entries.

5. The apparatus as claimed in claim 4, wherein said additional entry comprises another digit entered by the user using the key pad.

6. The apparatus as claimed in claim 5, wherein said additional entry comprises a navigational key entry.

7. The apparatus as claimed in claim 5, wherein said component for selecting comprises a navigational key.

8. The apparatus as claimed in claim 3, wherein the communication terminal includes one or more line keys, and said component for dialing is responsive to one of the line keys being selected by the user.

9. The apparatus as claimed in claim 2, wherein the communication terminal includes a handset, and said component for dialing is responsive to said hands,et being lifted by the user.

10. A method for pre-dialing a number stored in a directory for a communication terminal, said communication terminal having a key pad for a user to enter digits, said method comprising the steps of:
accepting one or more digits entered by the user;
comparing said entered digits to a plurality of entries stored in the directory;
retrieving entries having digits matching the digits entered by the user;
prompting the user for an additional input if the retrieved entries include more than one entry;
selecting one of the retrieved entries in response to the additional input by the user;
dialing the number associated with the selected entry.

11. The method as claimed in claim 10, further including the step of counting the digits received, and said step of comparing said entered digits being performed when a predetermined number of digits are received.

12. The method as claimed in claim 11, wherein said additional input is provided by the user using a navigational input.

13. The method as claimed in claim 11, wherein said additional input comprises one or more digits entered by the user, and the additional digits result in a single entry matching the digits entered by the user.

14. The method as claimed in claim 13, wherein said entries comprise the number and a name, said name being mapped to digits on the key pad.

15. The method as claimed in claim 14, wherein said step of comparing includes comparing said entered digits to the number for each of said entries and comparing said entered digits to the digits mapped to the name for each of said entries.

16. The method as claimed in claim 15, wherein said step of dialing is responsive to an off-hook state in the communication terminal.

17. A system for pre-dialing a number stored in a directory for a communication terminal, said communication terminal having a key pad for a user to enter digits, said method comprising the steps of:
means for inputting one or more digits entered by the user;
means for comparing said entered digits to a plurality of entries stored in the directory;
means for retrieving entries having digits matching the digits entered by the user;
means for prompting the user for an additional input if the retrieved entries include more than one entry;
means for selecting one of the retrieved entries in response to the additional input by the user;
means for pre-dialing the number associated with the selected entry.

18. The system as claimed in claim 17, further including means for counting the digits received, and said means for comparing being responsive to said means for counting for comparing said entered digits when a pre-determined count is reached.

19. The system as claimed in claim 18, wherein said entries comprise the number and a name, said name being mapped to digits on the key pad.

20. The system as claimed in claim 19, wherein said means for comparing includes means for comparing said entered digits to the number for each of said entries and means for comparing said entered digits to the digits mapped to the name for each of said entries.
